(19) United States
(12) Patent Application Publication
(10) Pub. No.: US 2020/0273652 A1
(43) Pub. Date: Aug. 27, 2020

(54) EXTERIOR OPERATION DEVICE OF MOLDED CASE CIRCUIT BREAKER

(71) Applicant: LSIS CO., LTD., Anyang-si (KR)

(72) Inventor: Insu SEO, Anyang-si (KR)

(21) Appl. No.: 16/586,308

(22) Filed: Sep. 27, 2019

(30) Foreign Application Priority Data
Feb. 21, 2019 (KR) 10-2019-0020705

(51) Int. Cl. H01H 71/52; H02H 3/10; H01H 71/02

(52) U.S. Cl. CPC H01H 71/52; H01H 2221/08; H01H 71/0207; H02H 3/105

(57) ABSTRACT

The present disclosure relates to an exterior operation device of a molded case circuit breaker, and particularly, to a cable of an exterior operation device of a molded case circuit breaker. The exterior operation device includes a molded case circuit breaker equipped with a handle; a control assembly rotatably installed to a mounting bracket to which the molded case circuit breaker is mounted, and configured to move the handle; a remote control unit mounted spaced apart from the molded case circuit breaker and configured to provide an operation force to move the handle; and a cable assembly provided between the remote control unit and the molded case circuit breaker and configured to transmit the operation force. The cable assembly includes: a first outer cable; an inner cable; and a first elastic member disposed between the first outer cable and the inner cable.

### CROSS-REFERENCE TO RELATED APPLICATION

Pursuant to 35 U.S.C. § 119(a), this application claims the benefit of earlier filing date and right of priority to Korean Application No. 10-2019-0020705, filed on Feb. 21, 2019, the contents of which is incorporated by reference herein in its entirety.

### FIELD OF THE INVENTION

The present disclosure relates to an exterior operation device of a molded case circuit breaker, and particularly, to a cable of an exterior operation device of a molded case circuit breaker.

### BACKGROUND OF THE INVENTION

In general, a molded case circuit breaker is an electric instrument that is installed in part of an electric system to protect the circuit and load by automatically breaking the circuit in an electrical overload state or a short circuit fault.

The molded case circuit breaker generally includes a terminal part that may be connected to a power side or load side, a contact part including a fixed contact and a movable contact that may come in contact with or be separable from the fixed contact to connect or separate the circuit, a switching mechanism that moves the movable contact to supply power required to open/close the circuit, a trip part that detects an over-current or short circuit current at the power side to induce a trip motion of the switching mechanism, and an extinction part that extinguishes an arc occurred in cutting off an abnormal current. Here, at the top of the molded case circuit breaker, a handle is provided to turn on/off the switching mechanism by a user's manipulation.

Meanwhile, an external control device is provided to remote control the molded case circuit breaker (for instance, when the molded case circuit breaker is installed on a distribution board such that the molded case circuit breaker is manipulated outside the distribution board).

FIG. 1 illustrates an external manipulation device of a molded case circuit breaker according to the conventional art.

The external control device of a molded case circuit breaker according to the conventional art includes a device control unit coupled to the molded case circuit breaker, an external control unit installed at remote locations, and a power transfer unit that connects the device control unit to the external control unit.

The device control unit includes a mounting bracket 3 on which the molded case circuit breaker 1 is installed (or installed on the molded case circuit breaker 1), and a control assembly 4 rotatably installed on the mounting bracket 3 and coupled with the handle 2 so as to operate the handle 2.

When the control assembly 4 rotates, the handle 2 rotates together, so that the molded case circuit breaker 1 is turned on and off.

An external control unit is set up at remote locations such as doors of a distribution board (not shown). The external control unit includes an external mounting bracket 7, an external handle assembly 8, which is installed on the outside of the external mounting bracket 7, and a lever 6, which is installed on the inside of the external mounting bracket 7. Here, the external handle assembly 8 is equipped with an external handle 9 to receive the user's operating force.

When the user operates the external handle 9 in the on or off position, the lever 6 connected to it is rotated.

A power transfer unit is arranged between the device control unit and the external control unit. The power transfer unit may consist of cables 5. The covered part at one end of the cable 5 is secured to the external mounting bracket 7 of the external control unit, while the covered part at the other end of the cable 5 is secured to the mounting bracket 3 of the device control unit. One end of the cable 5 is connected to the lever 6 of the external control unit, and the other end of the cable 5 is connected to the control assembly 4 of the device control unit.

When the user lifts or lowers the external handle 9, the lever 6 rotates in conjunction with it, and the operating force pulls or pushes the control assembly 4 through the cable 5. Accordingly, the handle 2 of the molded case circuit breaker 1 switches to the on or off state.

However, in the conventional art, increasing the rated capacity of the product increases the size of the molded case circuit breaker 1 and therefore requires significant operating effort of the handle 2. In other words, the displacement of the cable 5 is increased. In such cases, the internal friction of the cable 5 incidentally increases. Also, friction and damage of parts may occur as users operate with an excessive force.

### SUMMARY OF THE INVENTION

Therefore, an aspect of the detailed description is to provide an exterior operation device of a molded case circuit breaker that is capable of increasing the power of a cable.

To achieve these and other advantages and in accordance with the purpose of this specification, as embodied and broadly described herein, an exterior operation device of a molded case circuit breaker includes: a molded case circuit breaker equipped with a handle; a control assembly rotatably installed on a mounting bracket to which the molded case circuit breaker is mounted, and configured to move the handle; a remote control unit mounted separately from the molded case circuit breaker and configured to provide an operation force to move the handle; and a cable assembly provided between the remote control unit and the molded case circuit breaker and configured to transfer the operation force, wherein the cable assembly includes a first outer cable connected to the remote control unit; an inner cable having one end inserted to slide into an operating groove formed along the length direction of the outer cable; and a first elastic member disposed between the first outer cable and the inner cable.

Here, the remote control unit includes a remote mounting bracket; a handle holder fixed to the remote mounting bracket; a handle rotatably mounted to the handle holder; and a handle lever rotatably mounted to the remote mounting bracket and rotated by the rotational force of the remote handle.

In addition, the cable assembly further includes a covering member that encloses the outer cable and the inner cable.

In addition, both ends of the covering member are fixed by a fixing bracket to the mounting bracket or the remote mounting bracket, respectively.

In addition, an insertion groove is installed on the inner cable, and a restraining member is mounted to expose from the insertion groove.

In addition, the first outer cable includes a latched groove, which constrains the movement of the inner cable when the restraining member is caught in the latched groove.

In addition, the insertion groove includes a second elastic member which provides an elastic force in the direction of pushing out the restraining member.

In addition, when the restraining member is caught in the latched groove, the first elastic member is placed in a compressed state.

In addition, the elastic force of the first elastic member is set greater than the elastic force of the second elastic member.

In addition, the other end of the inner cable includes a second outer cable, to which is formed in the same way as the first outer cable.

According to the exterior operation device of the molded case circuit breaker in accordance with an embodiment of the present disclosure, the cable consists of inner and outer cables acting between elastic members, which increase the action force and distance.

As a result, users can apply small forces to make it easier to use them. In addition, the possibility of incidental damage is reduced.

### BRIEF DESCRIPTION OF THE DRAWINGS

FIG. 1 is a perspective view illustrating a conventional exterior operation device of a molded case circuit breaker.

FIG. 2 is a perspective view illustrating an exterior operation device of a molded case circuit breaker in accordance with an embodiment of the present disclosure.

FIGS. 3 and 4 are exemplary views illustrating the operation state of the exterior operation device of a molded case circuit breaker in accordance with an embodiment of the present disclosure, in which the device is in an on-state and off-state, respectively.

FIGS. 5 through 7 are exemplary views illustrating the operation state of the cable applied to the exterior operation device of a molded case circuit breaker in accordance with an embodiment of the present disclosure.

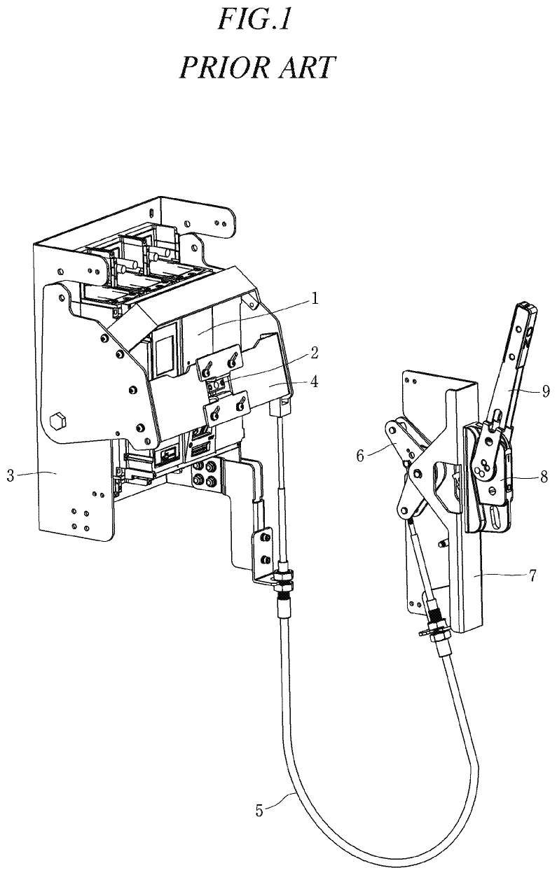

### DETAILED DESCRIPTION OF THE INVENTION

Hereinafter, preferred embodiments of the present invention will be described with reference to the accompanying drawings, so that a person skilled in the art can easily carry out the invention. It should be understood that the technical idea and scope of the present invention are not limited to those preferred embodiments.

Hereinafter, description will be given in detail of the exterior operation device of the molded case circuit breaker in accordance with the embodiments of the present disclosure.

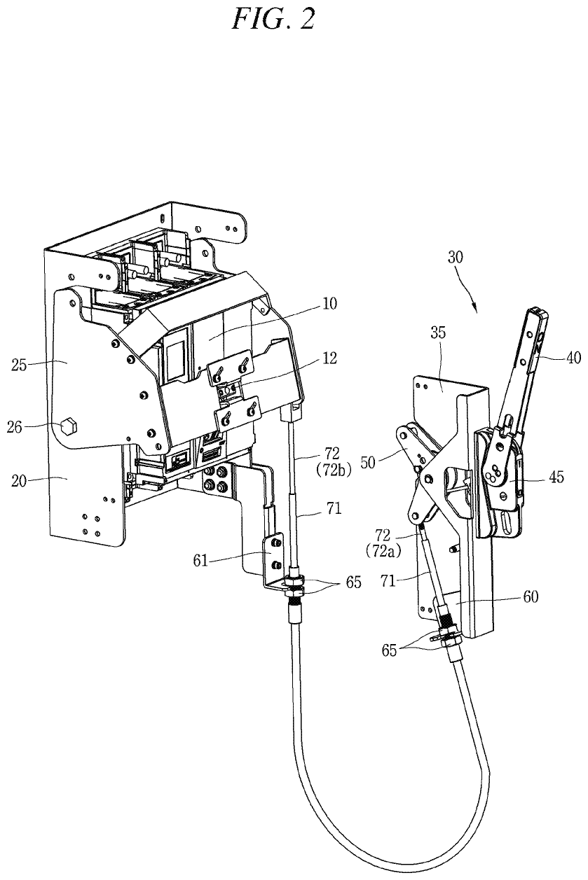

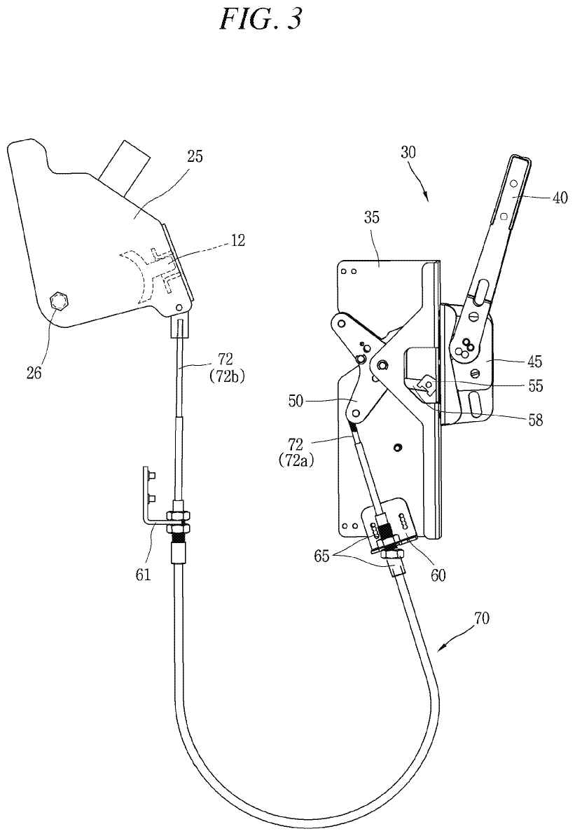

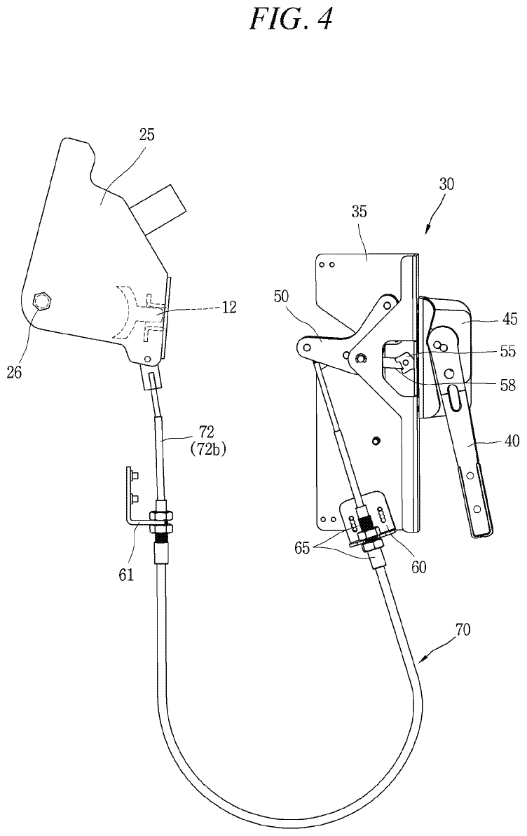

FIG. 2 is a perspective view illustrating an exterior operation device of a molded case circuit breaker in accordance with an embodiment of the present disclosure, and FIGS. 3 and 4 are exemplary views illustrating the operation state of the exterior operation device of a molded case circuit breaker in accordance with an embodiment of the present disclosure, in which the device is in an on-state and off-state, respectively.

The exterior operation device of a molded case circuit breaker in accordance with an embodiment of the present disclosure includes a molded case circuit breaker 10 equipped with a handle 12; a control assembly 25 rotatably installed on a mounting bracket 20 to which the molded case circuit breaker 10 is mounted, and configured to move the handle 12; a remote control unit 30 mounted separately from the molded case circuit breaker 10 and configured to provide an operation force to move the handle 12; and a cable assembly 70 provided between the remote control unit 30 and the molded case circuit breaker 10 and configured to transfer the operation force, in which the cable assembly 70 further includes a first outer cable 72a connected to the remote control unit 30; an inner cable 76 having one end inserted to slide into an operating groove 73 formed to along the length direction of the outer cable 72a; and a first elastic member 83 disposed between the first outer cable 72a and the inner cable 76.

The molded case circuit breaker 10 may be a conventional molded case circuit breaker with a rated capacity. A handle 12 is protruded from the outer enclosure of the molded case circuit breaker 10. The user can operate the handle 12 to switch the molded case circuit breaker 10 to the on or off state.

The exterior operation device of a molded case circuit breaker includes a device control unit that is fitted to the molded case circuit breaker, an external control unit installed at a remote location, and a power transfer unit that connects the device control unit with the external control unit.

The device control unit includes a mounting bracket 20 and a control assembly 25.

The molded case circuit breaker 10 is installed on the mounting bracket 20. Alternatively, the mounting bracket 20 may be installed on the molded case circuit breaker 10. The mounting bracket 20 may be formed in the form of a “E”. The mounting bracket 20 may be formed by enclosing the molded case circuit breaker 10. That is, the mounting bracket 20 may accommodate the molded case circuit breaker 10 therein.

A control assembly 25 is rotatably mounted on the mounting bracket 20. Part of the control assembly 25 is secured with the handle 12, which moves in conjunction with the control assembly 25. When the control assembly 25 is rotated, the handle 12 is rotated together, causing the molded case circuit breaker 10 to be on or off.

Part of the control assembly 25 is connected to the end of the cable, which moves the control assembly 25.

A remote control unit 30 is provided at a location separated from the molded case circuit breaker 10. For example, the remote control unit 30 may be installed in a door on a distribution board (not shown). The remote control unit 30 includes a remote mounting bracket 35, a remote handle assembly 40 and 45, and a handle lever 50.

The remote mounting bracket 35 is installed in a separate location from the molded case circuit breaker 10. For example, the remote mounting bracket 35 may be installed on the door of the distribution board (not shown). The remote mounting bracket 35 may be fitted with a remote handle assembly 40 and 45 on the front or outer surface, and a handle lever 50 on the back or inner surface.

The remote handle assembly 40 and 45 includes a remote handle 40 and a handle holder 45.

The handle holder 45 is installed on the remote mounting bracket 35. The handle holder 45 includes a remote handle 40 and may be moved to the on/off position. The handle holder 45 may include an axis anchorage that supports the remote handle 40 and a handle support that is formed on the left and right sides of the axis anchorage and ensures that the remote handle 40 is secured in the on or off position.

The remote handle 40 is rotatably installed in the handle holder 45. For example, the remote handle 40 may be switched off when it is rotated downward or on when it is rotated upward.

Rotation of the remote handle 40 is transferred to rotate the handle lever 50. Here, a transfer mechanism may be disposed between the remote handle 40 and the handle lever 50. Such a transfer device may be a link, lever, or cable. For example, a transfer device consisting of a transfer lever 55 and a transfer link 58 is shown. Rotating the remote handle 40 rotates the handle lever 50 clockwise or counterclockwise through the transfer lever 55 and the transfer link 58. In addition, the transfer mechanism may consist of a device that transmits the rotational force of the remote handle 40 to the rotation force of the handle lever 50.

Parts of the remote mounting bracket 35 and the mounting bracket 20 may be fitted with fixing brackets 60 and 61 to secure the ends of the covering member 71 of the cable assembly 70. Here, the cable assembly 70 may be fitted to the fixing brackets 60 and 61 by means of the fastening member 65. The fastening member 65 may consist of bolts and nuts.

A power transfer unit is prepared for transferring the operating force of the remote control unit to the device control unit. This means that the power transfer unit is prepared to transfer the operating force of the remote handle 40 to the control assembly 25. The power transfer unit may consist of a cable assembly 70.

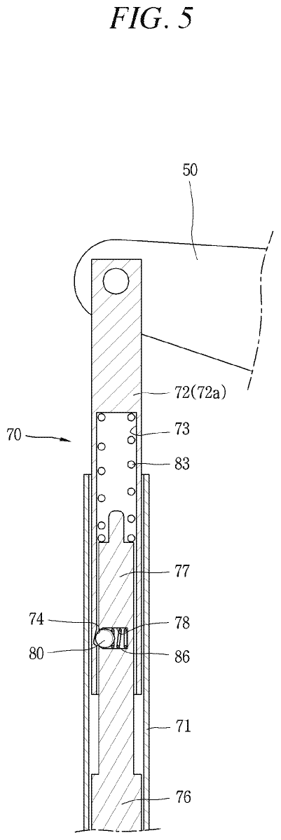

FIG. 5 illustrates an end portion of the cable assembly 70. The cable assembly 70 includes a covering member 71, an outer cable 72, an inner cable 76, a restraining member 80, a first elastic member 83, and a second elastic member 86.

The covering member 71 may be formed to have the length to enclose part of the inner cable 76 and outer cable 72. The covering member 71 may be made from synthetic resins or fiber materials.

The outer cable 72 is formed by a certain length. At this time, one end of the outer cable 72 is engaged with one end of the handle lever 50. The other end of the outer cable 72 is coupled to the fastening member 65. Therefore, it is recommended that the length of the outer cable 72 is formed by the length of which the other end of the outer cable 72 can be joined to the fastening member 65.

Inside the outer cable 72, an operating groove 73 is formed that allows the inner cable 76 to be inserted along the length direction.

Part of the operating groove 73 of the outer cable 72 is formed with a latched groove 74 that may be caught by a restraining member 80.

The outer cable 72 is provided in pairs. The first outer cable 72a is secured to the handle lever 50, while the second outer cable 72b is secured to the mounting bracket 20. (A pair of outer cables may be formed equally. Depending on the part placed, it may be divided into the first and second outer cables. If such a distinction is necessary, it is decided to add the subscripts a,b).

The inner cable 76 is slidably installed in the operating groove 73 of the first outer cable 72a.

A first elastic member 83 is interposed between the inner cable 76 and the outer cable 72a. In other words, the first elastic member 83 is inserted in the operating groove 73 and connected to the first end of the inner cable 76. The inner cable 76 is subjected to the elastic force by the first elastic member 83 within the operating groove 73.

The inner cable 76 includes an insertion groove 78 that allows the insertion of a restraining member 80 in the radial direction. The insertion groove 78 is equipped with a restraining member 80 and a second elastic member 86.

The restraining member 80 may be formed in the form of spheres or bullets. The restraining member 80 is subjected to the force released outside the insertion groove 78 by the second elastic member 86. However, the entrance of the insertion groove 78 is formed smaller than the diameter of the restraining member 80, so that the restraining member 80 is partially exposed to and does not deviate from the entrance of the insertion groove 78.

When the restraining member 80 is caught in the latched groove 74, as shown in FIG. 5, the inner cable 76 is placed in the operating groove 73 of the outer cable 72 without moving.

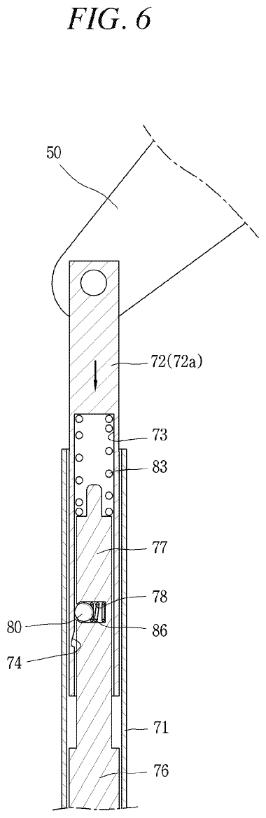

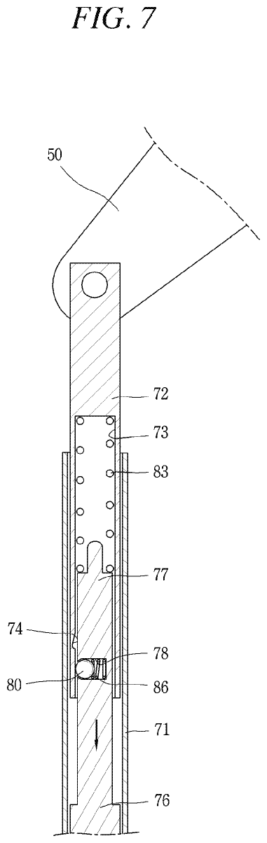

When the restraining member 80 leaves the latched groove 74, as shown in FIG. 6 or 7, and is not restrained, the inner cable 76 slides from the operating is groove 73 of the outer cable 72, and moves.

Meanwhile, the elastic force (or elastic coefficient) of the first elastic member 83 may be set relatively large, while the elastic force (or elastic coefficient) of the second elastic member 86 may be set relatively small. For example, the elastic force of the first elastic member 83 may be set greater than the elastic force of the second elastic member 86. Accordingly, when the restraining member 80 is released from the restraint of the latched groove 74, the restraining member 80 will overcome the elastic force of the second elastic member 86 by the speed at which the inner cable 76 is advanced by the first elastic member 83, so that the restraining member 74 will not become trapped.

Referring to FIGS. 3 to 7, description will be given of the operation of the exterior operation device of the molded case circuit breaker in accordance with the embodiment of the present disclosure.

Consider switching from an off state as shown in FIG. 4 to an on state as shown in FIG. 3, when the remote handle 40 is off as shown in FIG. 4, the first outer cable 72a of the remote control unit 30 is pulled. Accordingly, the second outer cable 72b of the device control unit is also pulled and the molded case circuit breaker 10 is in an off state.

At this time, the restraining member 80 of the inner cable 76 is caught in the latched groove 74 of the first outer cable 72a (see FIG. 5). Here, the first elastic member 83 lies in a state of some compression (storage of elasticity) between the inner cable 76 and the first outer cable 72a. Thus, the inner cable 76 is subjected to elastic force by the first elastic member 83.

When the remote handle 40 is rotated upward to move to the on-position, the handle lever 50 pushes the first outer cable 72a, while rotating counterclockwise. Accordingly, the first outer cable 72a moves in the direction of the inner cable 76 and the restraining member 80 deviates from the latched groove (see FIG. 6).

Accordingly, the inner cable 76 is forced (pushed) forward by the resiliency of the first elastic member 83 (see FIG. 7). Here, when the elastic force of the first elastic member 83 is set sufficiently large, the inner cable 76 is too fast to be ejected by the resiliency of the first elastic member 83 (e.g., if the elastic force of the first elastic member 83 is set greater than the elastic force of the second elastic member 86, and the restraining member 80 is not inserted into the latched groove 74. Thus, the inner cable 76 can advance by the length of the first elastic member 83. Thus, the movement of the inner cable 76 is transferred to the outer cable 72b which is then advanced and pushed through the control assembly 25 so that the handle 12 is moved to the on-position.

At this time, the elastic force of the first elastic member 83 is added to move the inner cable 76 so that it moves the control assembly 25 with a force greater than the user's action force.

Meanwhile, the second outer cable 72b may act as opposed to the action of the first outer cable 72a. That is, when the first outer cable 72a is advanced and the first elastic member 83 is extended, the first end of the inner cable 77 is moved away from the first outer cable 72a, and the second end (not numbered) of the inner cable 72 is inserted into the operation groove of the second outer cable 72b, to compress the first elastic member 83b at the second outer cable 72b.

When the user operates the remote handle 40 in the off-state, the action will occur in the opposite direction from the previous example.

According to the exterior operation device of the molded case circuit breakers in accordance with an embodiment of the present disclosure, the cables consist of inner and outer cables acting between elastic members, which increase the action force and distance.

As a result, users can apply small forces to make it easier to use them. In addition, the possibility of component failure is reduced.

While the invention has been shown and described with reference to the foregoing preferred embodiments thereof, it will be understood by those skilled in the art that various changes and modifications may be made without departing from the spirit and scope of the invention as defined by the appended claims. Therefore, the embodiments disclosed in the present disclosure are not intended to limit the scope of the present disclosure but are merely illustrative, and it should be understood that the scope of the technical idea of the present disclosure is not limited by those embodiments. That is, the scope of protection of the present invention should be construed according to the appended claims, and all technical ideas within the scope of equivalents thereof should be construed as being included in the scope of the present invention.

What is claimed is:

1. An exterior operation device of a molded case circuit breaker, comprising:
a molded case circuit breaker equipped with a handle;
a control assembly rotatably installed to a mounting bracket to which the molded case circuit breaker is mounted, and configured to move the handle;
a remote control unit mounted separately from the molded case circuit breaker and configured to provide an operation force to move the handle; and
a cable assembly provided between the remote control unit and the molded case circuit breaker and configured to transfer the operation force,
wherein the cable assembly includes:
a first outer cable connected to the remote control unit;
an inner cable having one end inserted to slide into an operating groove is formed along the length direction of the outer cable; and
a first elastic member disposed between the first outer cable and the inner cable.

2. The exterior operation device of claim 1, wherein the remote control unit includes:
a remote mounting bracket;
a handle holder fixed to the remote mounting bracket;
a handle rotatably mounted to the handle holder; and
a handle lever rotatably mounted to the remote mounting bracket and rotated by the rotational force of the remote handle.

3. The exterior operation device of claim 1, wherein the cable assembly further includes a covering member that encloses the outer cable and the inner cable.

4. The exterior operation device of claim 3, wherein both ends of the covering member are fixed by a fixing bracket to the mounting bracket or the remote mounting bracket, respectively.

5. The exterior operation device of claim 1, wherein an insertion groove is installed on the inner cable, and a restraining member is mounted to expose from the insertion groove.

6. The exterior operation device of claim 5, wherein the first outer cable includes a latched groove configured to constrain the movement of the inner cable when the restraining member is caught in the latched groove.

7. The exterior operation device of claim 5, wherein the insertion groove includes a second elastic member which provides an elastic force in the direction of pushing out the restraining member.

8. The exterior operation device of claim 6, wherein when the restraining member is caught in the latched groove, the first elastic member is placed in a compressed state.

9. The exterior operation device of claim 7, wherein the elastic force of the first elastic member is set greater than the elastic force of the second elastic member.

10. The exterior operation device of claim 1, wherein the other end of the inner cable includes a second outer cable, which is formed in the same way as the first outer cable.
